(19) United States
(12) Patent Application Publication
(10) Pub. No.: US 2007/0007339 A1
(43) Pub. Date: Jan. 11, 2007

(54) Process for storing and sorting surgical instruments

(75) Inventor: Jean-Albert Despres, Souesmes (FR)

Correspondence Address: LEYDIG VOIT & MAYER, LTD, 700 THIRTEENTH ST. NW, SUITE 300, WASHINGTON, DC, 20005-3960, US

(73) Assignee: CYRIL DE UTHEMANN, Vandoeuvres (CH)

(21) Appl. No.: 11/478,375

(22) Filed: Jun. 30, 2006

(30) Foreign Application Priority Data
Jul. 4, 2005 (FR) 05 07 081

(51) Int. Cl. G06Q 30/00; G06F 17/00

(52) U.S. Cl. 235/385; 235/375

(57) ABSTRACT

A process and apparatus for sorting and storage of surgical instruments. The apparatus includes an enclosure filled with a pure atmosphere and containing a device for the storage of clean instruments, a device for transport of the instruments to a station for identification of the instruments, a mechanism for storage of identified instruments in containers, and an information processing device for control of the apparatus.

The invention concerns a process for the sorting and storage of instruments, such as surgical instruments, which are to be used for a predetermined operation, such as a surgical operation, and an installation for implementation of this process.

With regard to known processes of this type, for example, in the field of surgical operations, the sorting and storage of the surgical instruments to be used by the surgeon are performed by persons who are supposed to assist the surgeon. The processes involve the major disadvantages that errors may be committed during the preparation and choice of instruments, on the one hand, and that obstacles to the hygienic requirements may occur, on the other.

The purpose the invention is to propose a process and an installation that makes it possible to palliate these disadvantages.

In order to realize this purpose, the process according to the invention is characterized by the fact that for each surgical operation that can be performed, an operation protocol is established, indicating at least the instruments that are to be used and, if applicable, their order of use, that each instrument of a set of instruments capable of being used during the course of a number of operations is provided with an identification code, and the sorting of the instruments necessary for a predetermined operation is accomplished automatically in an enclosure with a pure atmosphere by ensuring the transport of the instruments from a storage area to a station for identification of the instruments by reading their codes and storing the instruments after their identification, as a function of the operation protocols, in containers, each of which holds the instruments necessary for an operation.

The installation according to the invention is characterized by the fact the interior of an enclosure with a pure atmosphere contains a device for the storage of clean instruments, a device for the transport of the instruments to a station for identification by reading the identification codes of the instruments, and a mechanism for storing the recognized instruments in operation containers, each of which contains the instruments intended for an operation, as a function of the operation protocols.

The invention will be better understood and other aims, characteristics, details and advantages of the invention will appear more clearly during the course of the following explanatory description with reference to the appended schematic drawings, given only by way of example, which illustrate an embodiment of the invention and in which:

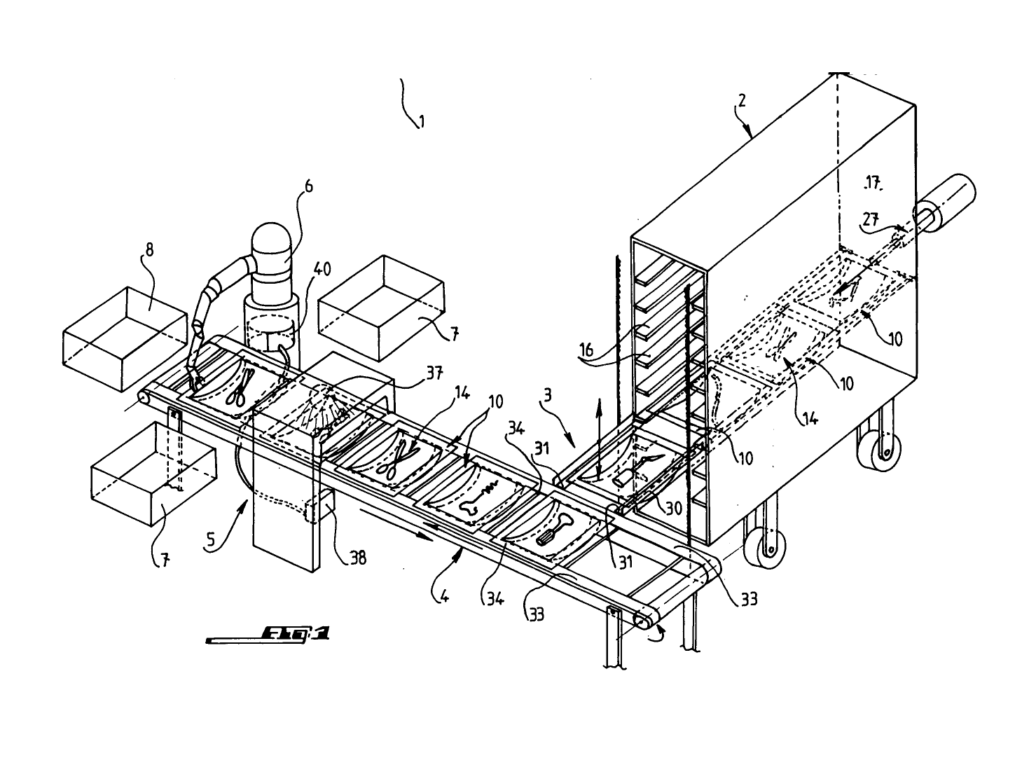

FIG. 1 is a schematic view in perspective of an installation according to the invention;

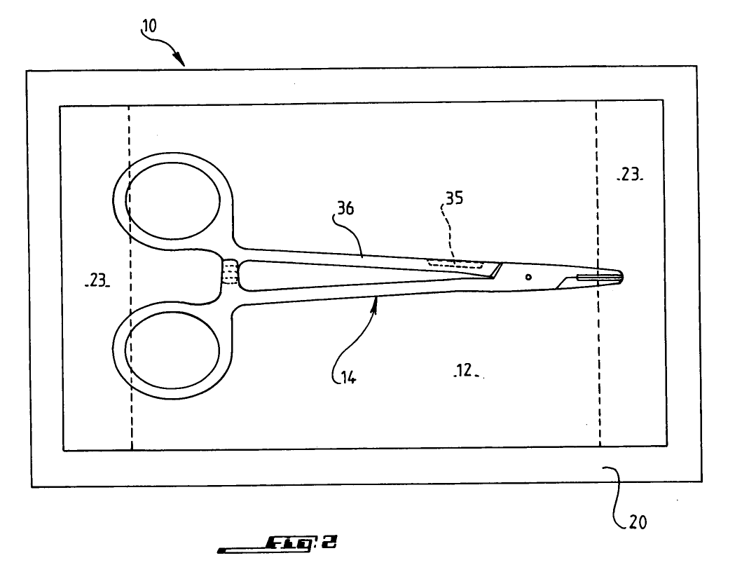

FIG. 2 is a top view of an instrument support tray according to the invention;

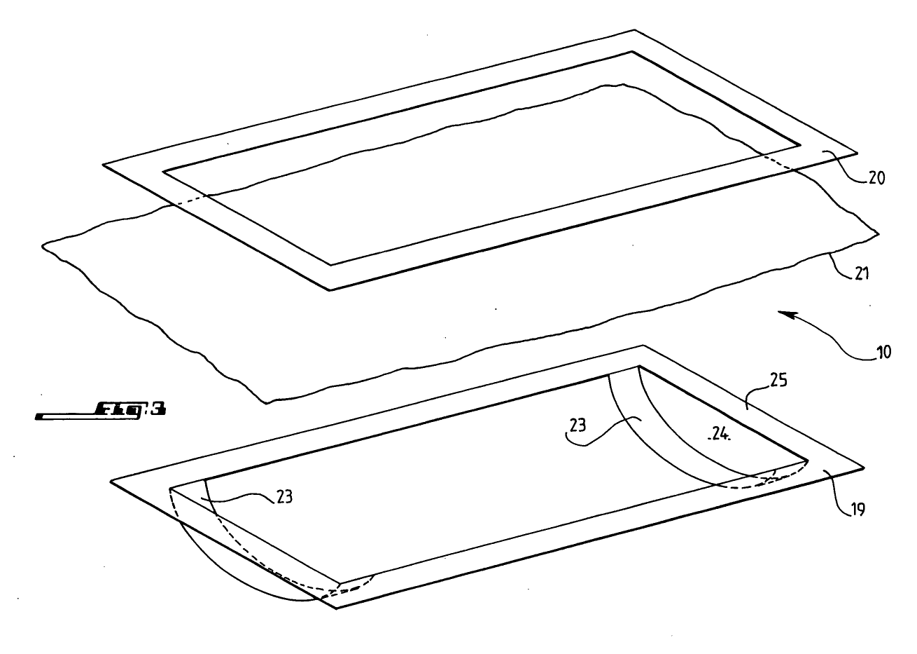

FIG. 3 is an exploded view of a support tray according to FIG. 2; and

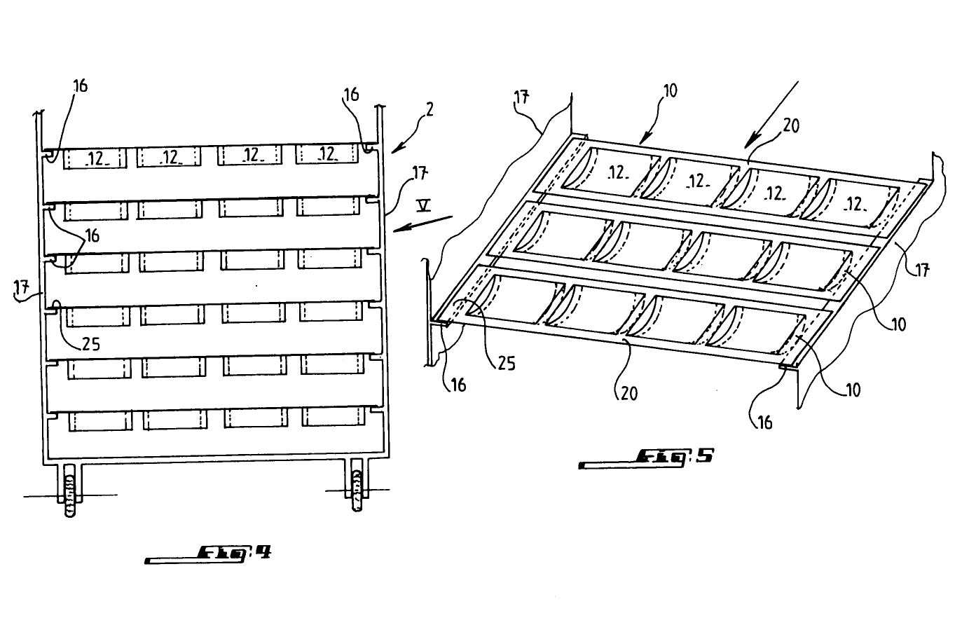

FIGS. 4 and 5 illustrate an advantageous configuration of the trays according to the invention and of a storage stage.

The invention will be described hereafter in its application to a process for the sorting of surgical instruments for surgical operations. Of course, the description is given only by way of example; however, in a general manner, the invention can be used for any operation involving a specific selection and storage of instruments for carrying out the operation.

With reference to FIG. 1, it is observed that an installation according to the invention for the sorting of the instruments necessary for a surgical operation essentially comprises, arranged inside of enclosure 1 with a pure atmosphere, that is, of the most perfect cleanliness possible, essentially a device for the storage of all of the surgical instruments likely to be used for the different possible surgical operations, in the clean state, device 3 for the transfer of the instruments to conveyor 4 intended for transporting them to station 5 for identification of the nature or type of the instruments, and a mechanism for storing the instruments after their identification in containers 7, each of which is intended for holding the instruments which are to be used for a predetermined operation, container 8 being provided for receiving instruments considered to be not in accordance with the requirements established for surgical operations.

Device 2 for the storage of all of the instruments is realized in the example in the form of a trolley with a certain number of levels 9 each for holding a number of trays 10, three in the example represented, each of which can have a number of chambers 12 for housing surgical instrument 14. In this specific case, for reasons of simplification of the drawings, each tray only has one chamber. Trays 10 of each level 9 of storage trolley 2 are supported by support elements in the form of slide rails 16 each attached to lateral wall 17 of the trolley oriented in the direction of conveyor 4.

In reference to FIG. 3, it is observed that each tray 10 is composed of two superposed frames of a material that is easy to clean such as stainless steel, i.e., lower frame element 19 with a general rectangular shape and upper frame 20 of complementary shape that can be fixed to the lower frame by means in the form of clips (not represented) which are capable of pressing the upper frame against the lower frame so that disposable element 21, made of a flexible material transparent to X-rays, advantageously paper or fabric, could be inserted at two of its opposite edges between the corresponding edges of the two frames in order to form chamber 12 for housing instrument 14. For easy formation and maintaining of the chambers, lower frame 19 is provided with support elements 23 in the form of arches at each longitudinal end. It is advantageous for the chamber to be closed at each longitudinal end by vertical wall 24 forming the space between the frame and the corresponding arch 23.

As seen in FIG. 1, each tray 10 is displaceable in trolley 2, perpendicular to its longitudinal axis, and resting by short sides 25 on slide rails 16 of the trolley.

The arrangement for the transfer of trays 10 of each stage of the trolley entails, in order to push the trays out of the trolley, pushing device 27 mounted so as to be vertically movable at the rear of trolley 2, so that it can be positioned at each level 9 of the trolley. The device has a pushing piston of a hydraulic jack which, during its outward movement, pushes the last tray and thus moves all of the trays in the direction of the conveyor.

Transfer device 3 moreover has, in front of storage trolley 2 for trays 10, frame 30 for the transfer of trays 10 from trolley 2 to conveyor 4, which can be moved vertically so that it can receive the trays of each storage level 9 of the trolley in order to then transport them to the level of conveyor 4 so that the trays can be placed on the conveyor. More precisely, in the example represented, the transfer frame essentially has two slide rails 31, each capable of being aligned, in a position for receiving a tray from level or stage 9, with slide rail 16 of the level, so that trays 10 can be moved under the effect of pushing device 27 from rails 16 of the trolley to rails 31 of transfer frame 30. The transfer frame is dimensioned in such a way as to successively transfer trays 10 to conveyor 4.

Conveyor 4 is shown in FIG. 1 in the form of an endless conveyor belt with essentially two parallel flat belts 33 for the transport of trays 10, which are connected by crosspieces 34.

In order to ensure the transfer of trays 10 from transfer frame 30 to conveyor belts 33, support rails 31 of the transfer frame extend to the point that they are over the conveyor, and its tray support portion, in its position before transfer, can be lowered in order to allow the trolleys to be placed over the belts of the conveyor situated below. Then they move away laterally and return to their position for receiving another tray.

Conveyor 4 transports the trays, received from storage trolley 2 by means of transfer frame 3, to station 5 for identification of the instruments placed in chambers 12 of trays 10. Concerning the surgical instruments, which have different functions and shapes, each of them is provided with an identification code which can be recognized by station 5 so that the station can distinguish the instruments brought in by conveyor 4 according to their specific type. More precisely, the identification code of each instrument is marked in any appropriate form on insert 35, which is placed in an appropriate cavity machined in the instrument and then closed. FIG. 2 shows as an example surgical forceps with insert 35 incorporated in one of its branches designated 36.

The station for identification of the instruments is advantageously an X-ray reader in the form of a portal through which conveyor 4 passes and which has, arranged above conveyor 4, X-ray source 37, while a receiver of the rays passing through instrument 14 is arranged below the conveyor.

So that it is possible to identify the type of instrument according to its insert, the elements of the insert which form the identification code must be less transparent to X-rays than the material constituting the instrument. This code could reside in the form of the insert or marks provided thereon. The inserts are advantageously produced from a material which is relatively opaque to X-rays, such as brass or a brass alloy. In order to ensure reliable identification of the instruments, it is necessary for the instruments to be presented at the identification station always in a clearly defined position.

After the identification of the instruments by reading their inserts using X-rays, information processing device 40 instructs storage apparatus 6 to grasp the instruments and store them in containers 7 in the form of boxes.

This device has operation protocols in its memory, one protocol for each type of operation, indicating the instruments which are to be used in the course of the operation, if applicable, in their order of use. Given that each type of operation corresponds to a box 7, the instruments to be stored in this box are indicated by the protocol established for this operation. For this purpose, information processing device 40 first identifies, according to the signal that it has just received from reader 38 of the identification station, the type of instrument which has just been examined and determines, by referring to the different protocols, which operation and thus for which box 7 an instrument of this type is intended. Then, it instructs storage device 6 to grasp the identified instrument in the tray and to store it in the appropriate box.

By comparing the instruments stored in a box with those appearing in the protocol, the information processing device knows at any time the “filling” state of each box 7. If it establishes that a box is complete, that is, that it contains all the instruments necessary for a given operation, the box is closed, for example, with a lid.

The invention also provides for the possibility of removing instruments considered unfit for use from the utilization circuit, by placing them in discard box 8. There could be various reasons for this measure, for example, an instrument could be worn, impossible to identify, or dirty.

Concerning storage station 6, apparatuses capable of functioning in the manner described above are generally known so that it is not necessary to describe precisely the apparatus used in the context of the invention. It is appropriate to indicate that such an apparatus has a robot arm capable of grasping the instruments in their tray and then placing them in the appropriate boxes as a function of the instructions received from the information processing device.

The functioning of the invention and the execution of the process as well as the different steps of the process proceed from the description just given. Needless to say, for each transfer of a tray onto the conveyor, the conveyor is stopped for the short time necessary for placement of the tray. The stops of the conveyor for loading of the trays and the process of identification of the instruments by the identification station as well as the storage of the instruments are coordinated by the information processing device.

The description of the invention just given is merely an example, and various modifications can be undertaken without deviating from the scope of the invention. In order to increase the storage capacity of trolley 2, each tray 10 could have four chambers, as shown by FIGS. 4 and 5. The arrow symbolizes the action of the mechanism for moving the tray toward conveyor 3.

It should be noted that the use of X-rays as a reading means allows the code elements to be placed inside of the instrument so that they are inaccessible to the outside. Consequently, the code information cannot be violated or altered. Reading using X-rays therefore excludes any reading errors which could occur by phenomena of wear and tear, corrosion or other changes in the exterior surface of the instruments. The reading is also completely insensitive to soiling deposits on the instruments. Furthermore, in the case of circular instruments which can be present in different angular positions, it is sufficient to make the insert have a profile of circular grooves for the reading to be always correct, independently of the rotational position of the instrument. On the other hand, in the case of flat instruments, it is sufficient for the code profile to be machined in the insert in the plane of the instrument so that correct reading is always effected.

1. A process for sorting and storage of surgical instruments, including:
establishing an operation protocol for respective surgical operations, indicating at least the surgical instruments which are to be used, an identification code being associated with each surgical instrument,
sorting the surgical instruments necessary for a predetermined operation, based on the operation protocol, in an enclosure in a pure atmosphere by transporting the instruments from a region of storage in a clean state to a station for identification of the surgical instruments by reading of the identification codes, and
storing the surgical instruments, after identification, in containers, each container holding the surgical instruments necessary for one of the operations.

2. The process according to claim 1, wherein each surgical instrument includes an insert bearing the identification code associated with the surgical instrument.

3. The process according to claim 2, wherein the insert is in a closed cavity in the surgical instrument.

4. The process according to claim 2, wherein the insert is a material which is more opaque to X-rays than the surgical instrument, and including reading of the identification code using X-rays.

5. The process according to claim 1, wherein after the identification of a surgical instrument by reading of an identification code, an operation for which the surgical instrument could be used is determined by consulting the operation protocols.

6. The process according to claim 5, including storage of a surgical instrument that has been identified in a container for holding the surgical instruments for a respective operation.

7. (canceled)

8. The apparatus according to claim 21, wherein the device for storing clean instruments includes a plurality of storage levels, each storage level having at least one tray for housing instruments.

9. The apparatus according to claim 8, wherein the device for storing includes a mechanism for removal of the trays from different storage levels onto a mechanism for transfer of the trays onto a conveyor, wherein the mechanisms for removal and for transfer can be displaced in height to servo respective storage levels.

10. The apparatus according to claim 9, wherein each storage level includes rails on which the trays can slide, and the mechanism for transfer includes tray slide rails which can be aligned with the rails of the storage levels.

11. The apparatus according to claim 10, wherein the slide rails of the mechanism for transfer extend over a conveyor, and an end part of the rails for the storage levels situated over the conveyor can be lowered and moved away place a tray supported on the rails on the conveyor.

12. The apparatus according to claim 9, wherein the mechanism for removal of the trays comprises pushing means for pushing a tray occupying a storage stage toward the mechanism for transfer.

13. The apparatus according to claim 21, wherein the device for storage contains a plurality of the trays.

14. The apparatus according to claim 8, wherein the device for storage includes a trolley.

15. The apparatus according to claim 14, wherein the tray has a lower frame and an upper frame with complementary shapes, the upper tray being fixed by pressing against the lower frame, and a flexible element arranged between the upper and lower frames, forming a chamber for housing of a surgical instrument.

16. The apparatus according to claim 15, wherein the frames are stainless steel, and the flexible element is a disposable material.

17. The apparatus according to claim 9, wherein the identification station comprises an X-ray source located above the conveyor and a detector of the X-rays passing through a tray inside the identification station the detector being located below the conveyor.

18. The apparatus according to claim 21, comprising a container for receiving instruments that are put aside as unsuitable for use.

19. The apparatus according to claim 21, wherein the information processing device coordinates operation of the apparatus.

20. The apparatus according to claim 21, wherein the surgical instrument comprises an insert in closed cavity of the surgical instrument and bearing coding elements identifying the surgical instrument, the insert being a material that is more opaque to X-rays than the surgical instrument.

21. An apparatus for sorting and storing of surgical instruments comprising:
an enclosure for containing a pure ambient;
a device for storing of clean surgical instruments and that is located within the enclosure;
a device for transporting the surgical instruments to an identification station that is located in the enclosure;
a mechanism for storing surgical instruments in containers after identification and that is located in the enclosure, each container holding surgical instruments for a particular operation protocol; and
an information processing device for control of the apparatus for sorting and storing surgical instruments.
